(19) United States
(12) Patent Application Publication
(10) Pub. No.: US 2012/0060403 A1
(43) Pub. Date: Mar. 15, 2012

(54) REPLACEMENT FISHING LINE GUIDE FOR A FISHING POLE

(76) Inventors: Charles M. LoPresti, Merritt Island, FL (US); James M. Lindquist, Satellite Beach, FL (US); Charles A. Noel, Melbourne, FL (US)

(21) Appl. No.: 13/226,329

(22) Filed: Sep. 6, 2011

Related U.S. Application Data
(60) Provisional application No. 61/380,195, filed on Sep. 3, 2010.

(51) Int. Cl. A01K 87/04

(52) U.S. Cl. 43/24

(57) ABSTRACT

A replacement fishing line guide for a fishing pole. The guide comprises a bendable base; at least a first and a second spaced-apart C-shaped clamp extending upwardly from the base, wherein the fishing pole is received within each of the first and second clamps, each clamp defining an opening therein, a first opening in the first clamp spaced a number of angular degrees from a second opening in the second clamp, a channel defined in a lower region of each of the first and second clamps, the channel for receiving remnant portions of a broken fishing line guide; a connecting segment extending from the base; and a ring attached to the connecting segment for receiving a fishing line within the ring.

### CROSS REFERENCE TO RELATED APPLICATIONS

This application claims the benefit of the Provisional Patent Application No. 61/380,195 filed on Sep. 3, 2010.

### FIELD OF THE INVENTION

The present invention relates to apparatuses and methods for the attachment of a replacement wire/line guide to a fishing pole.

### BACKGROUND OF THE INVENTION

Guides, also referred to as eyes, provide an unobstructed directed path for a fishing line along a fishing pole or fishing rod. According to the prior art, the guides are attached to the pole by gluing the guide in the proper location and orientation, then wrapping thread uniformly over guide leg(s) (also referred to as guide feet) in contact with the pole. Finally, a resin coating is applied to permanently secure the guide in place.

A guide can break from the pole as a result of corrosion or a careless accident. A broken or missing guide diminishes the ability to control the line and must be replaced before the pole can be used. Typically, a skilled technician is required to permanently replace the guide, a process that may take several weeks. Of course, the pole cannot be used while it is undergoing repair.

### BRIEF DESCRIPTION OF THE FIGURES

The various features of the invention embodiments will be apparent from the following more particular description of the invention, as illustrated in the accompanying drawings, in which like reference characters refer to the same parts throughout the different figures. The drawings are not to scale, with emphasis being placed upon illustrating the principles of the invention.

FIG. 1 is an illustration of a prior art fishing line guide attached to a fishing pole.

FIG. 2 is an illustration of a prior art fishing line guide that has been broken from the pole.

FIGS. 3 and 4 are isometric views of a fishing line guide of one embodiment of the invention.

FIGS. 5-9 illustrate various dimensions of the fishing line guide of one embodiment of the invention.

FIGS. 10 and 11 illustrate steps for removably attaching one embodiment of the fishing line guide of the present invention to a fishing pole.

FIGS. 12 and 13 illustrate flexing of one embodiment of the fishing line guide of the present invention.

FIG. 14 is an isometric view of a fishing line guide of a second embodiment of the invention.

FIGS. 15 and 16 illustrate steps for removably attaching a second embodiment of the fishing line guide of the present invention to a fishing rod.

FIG. 17 is an illustration of another embodiment of the fishing line guide of the present invention.

FIG. 18 is an illustration of another embodiment of a fishing line guide.

FIG. 19 is an illustration of yet another embodiment of a fishing line guide.

### DETAILED DESCRIPTION OF THE INVENTION

Before describing in detail exemplary embodiments of the replacement fishing line guide for a fishing pole, it should be observed that the present invention resides primarily in a novel and non-obvious combination of elements. So as not to obscure the disclosure with details that will be readily apparent to those skilled in the art, certain conventional elements have been presented with lesser detail, while the drawings and the specification describe in greater detail other elements pertinent to understanding the invention.

The following embodiments are not intended to define limits as to the structure of the invention, but only to provide exemplary constructions. The described embodiments are permissive rather than mandatory and illustrative rather than exhaustive.

To solve the problems associated with a broken guide, a clip-on replacement guide, according to one embodiment of the invention, defines one or more channels that provides ample space for any remaining vestiges of a broken guide foot or feet, and any remaining resin and thread that held the broken guide in place. This space permits a secure and stable connection between the replacement guide and the pole, over any remnant material of the original guide.

The replacement guide of the invention can be quickly and easily attached with a simple twist and with minimal force and minimal time. Hence, the fishing pole can be back in operation within a few seconds. The replacement guide allows the user to continue using the rod until he/she is able to bring the rod to a repair shop for a formal repair. However, a formal permanent repair may not be necessary as the replacement guide of the invention may be adequate to allow continued (i.e., permanent) use of the fishing pole. No special skills or training are needed to attach the replacement guide of the invention to the pole. The replacement guide stays in place due to the elastic forces inherent in the elastic characteristics of the guide material.

The inventive replacement guide may be made of metal or plastic or any material with similar properties. A non-corrosive material may be preferred, but a corrosive material can be used since the replacement guide can be replaced with a like guide if corrosion is present.

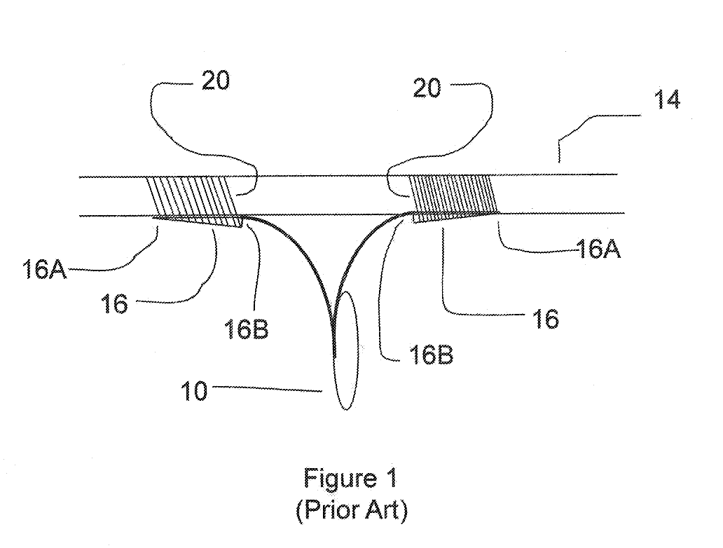

FIG. 1 illustrates the benefits of the channel of the replacement guide of the invention. FIG. 1 shows a prior art fishing line guide 10 connected to a fishing pole 14. Guide feet 16 are glued and wrapped with thread 20 and then coated with a resin material to securely attach the guide 10 to the pole 14. FIG. 1 shows a “two foot” guide, some guides have only one foot.

When a guide breaks off from a fishing pole, the feet (or fragments thereof) typically remain on the pole. These fragments increase the diameter of the fishing pole by the thickness of the foot, which typically can be thinner at one end 16A and thicker at another end 16B as shown in FIG. 1.

A user can cut any remaining broken guide material from the pole, such that only those portions of the guide feet that are wrapped in thread and resin remain on the pole, then install the replacement guide of the invention on the pole, directly over the guide feet fragments, thread and resin. The channel region of the inventive replacement guide allows the guide to fit over these fragments, resin and thread. Further, the design and installation technique of the replacement guide prevent movement of the guide notwithstanding any fragments, resin or thread that remain on the pole.

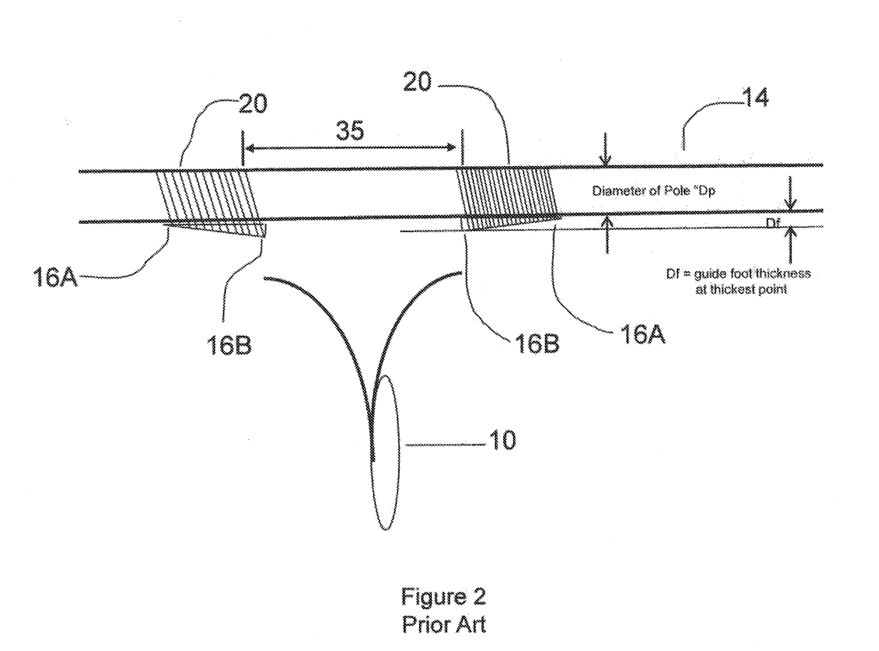

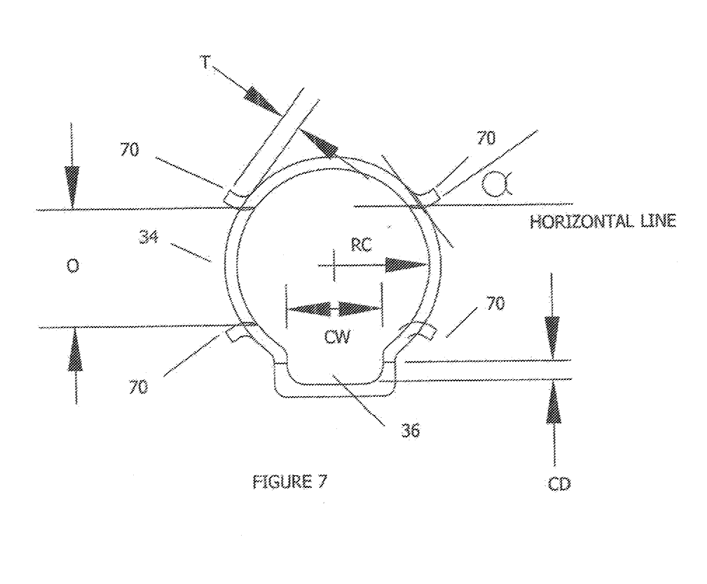

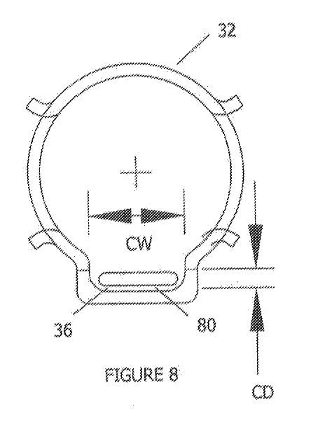

With the guide broken off as shown in FIG. 2, a diameter of the fishing pole 14 is now greater by a thickness of the guide feet fragment, plus the thread and resin that cover the broken guide feet. Defining a diameter of the pole as “Dp” and a thickness of a guide foot at it thickest point as “Df,” a channel depth “Cd” can be shown to be equal to about “Df.” The channel depth “Cd” is illustrated in FIGS. 7 and 8. FIG. 2 shows the broken guide 10 and the remaining feet fragments as well as the increase in the diameter of the pole 14 due to the thread and resin.

The purpose of the channel of the replacement guide is to accommodate this increased dimension “Df” such that clamps of the replacement guide fit in a snug and secure, i.e., non-slipping, manner over the broken guide feet, thread and resin.

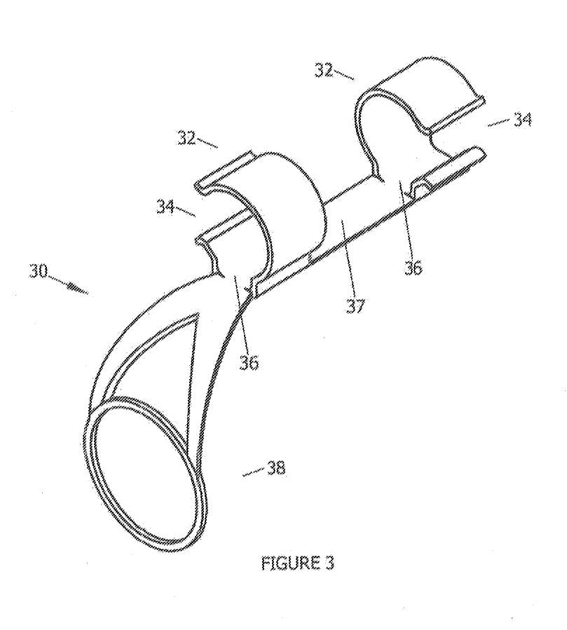

With respect to the problems described above, FIGS. 3, 6 and 7 below show the channel in more detail. FIG. 8 shows the dimension “Cd” in more detail with the broken guide feet fragments, thread and resin positioned within the channel.

FIG. 3 shows one embodiment of an inventive clip apparatus 30 (also referred to herein as a replacement guide or a replacement fishing line guide 30) comprising two “C-shaped” clamps 32 each defining an opening 34, the openings 34 having a 180 degree orientation relative to each other. FIG. 3 also shows a channel 36 extending a length of each “C-shaped” clamp 32. The clamps 32 may also be considered ring-like clamps with a portion of the ring material removed to form the “C-shaped” clamps.

In one embodiment a segment 37 (also referred to as a base or base segment) between the clamps 32 comprises a flat bendable or flexible segment that provides a stress relief to allow the clip 30 to bend (for example, either upwardly or downwardly or bendable in a direction perpendicular to a longitudinal axis of the base) as the fishing pole bends during fishing. When the replacement guide 30 is attached to the fishing pole 14 (not shown in FIG. 3), the segment 37 is positioned to span a region 35 (see FIG. 2) between any feet, thread and resin remnants that remain on the pole. With the guide 30 attached to a fishing pole 14 (not shown in FIG. 3), a fishing line (not shown in FIG. 3) passes through a ring 38.

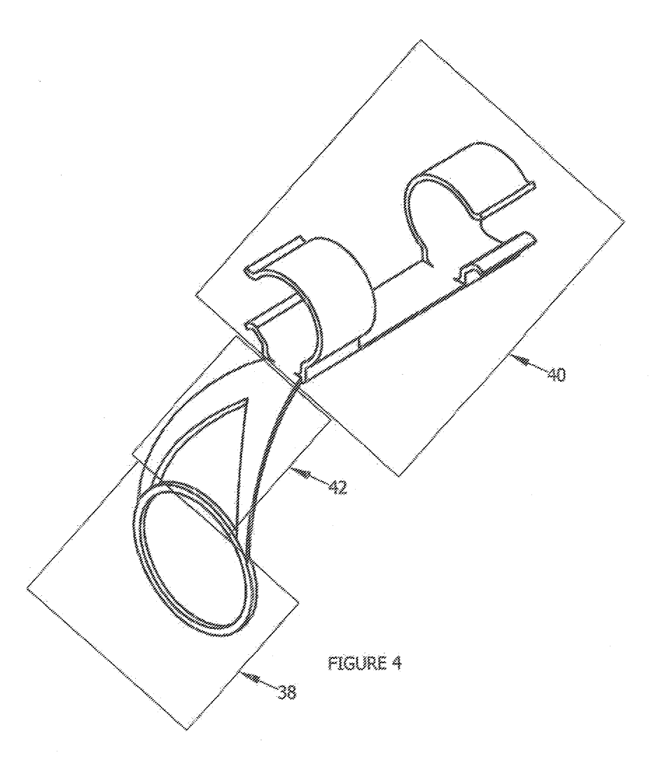

FIG. 4 is intended to simplify the discussion and description of the replacement guide 30. The guide 30 can be segregated into three different segments: a clip segment 40, a connecting segment 42 (extending from a short edge of the segment 37) and the ring 38.

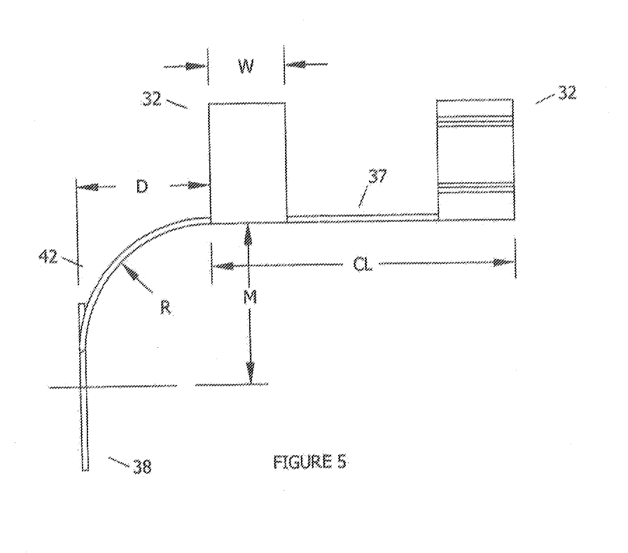

As shown in FIG. 5, the two “C-shaped” clamps 32 each have a width “W.” The center of the ring 38 extends below the clip apparatus 30 by a distance of “M” and extends in the forward direction from the front of the left-most “C-shaped” clamp 32 by a distance of “D.” The intermediate connecting section 42 has a radius of “R.” A length “CL” extends a length of each “C-shaped” clamp (i.e., a length of each channel 36 within each “C-shaped” clamp 32) and the segment 37.

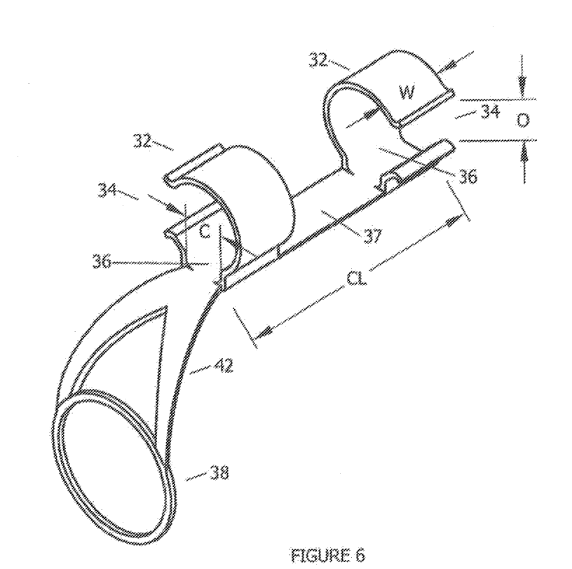

FIG. 6 is an isometric view showing the channel width “C”, the dimensional length “CL”, the width “W” of each clamp 32 and the size “O” of the clamp opening 34. As can be seen the channel 36 is defined in each clamp

As shown in FIG. 7, each “C-shaped” clamp 32 defines the opening 34 of length “O”, a channel width of “Cw” and a channel depth of “Cd” for each channel 36. Each clamp 32 also has two lips 70 having a length “T” bent in an outward direction at an angle of a with respect to a horizontal line. The lips serve as a “lead in” region for the clamps 32 during application of the clip 30 to the fishing pole.

The clamps 32 may be formed of a spring-like material that exerts inwardly-directed forces toward a center of the clamp to removably secure the clip apparatus 30 to the fishing pole 14. In securing the clamps 32 to the fishing pole 14, each clamp is deformed radially outwardly to permit the fishing pole 14 to pass through the openings 34 and the clamps then return to a pre-deformed state to exert the inwardly-directed forces. To impart these spring-like properties to the clamps 34, according to one embodiment the clamps undergo a heat treating process.

FIG. 8 shows the dimension “Cd” in greater detail, with remnants 80 of a broken guide foot positioned within the channel 36.

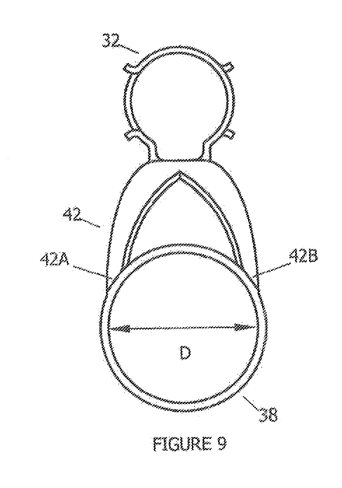

FIG. 9 is a front view showing a diameter of “D” of the ring 38, which can range from about 6 mm to about 50 mm. The connecting segment 42, which connects the ring 38 to the replacement clip 30, may have an open triangular section to form two attachment points 42A and 42B to the ring 38.

In the various illustrated embodiments, the clamps 32 have the same diameter/radius. But this property is not required and in another embodiment the clamps 32 have unequal diameters and/or radiuses. This feature may be beneficial to accommodate the tapering of the fishing pole. The difference in the two diameters may depend on the rate of rod taper over the distance “CL” of FIG. 5. In one application the rate of pole taper over the distance “CL” may not be significant and the size of the two clamps may therefore be equal. In another application the rate of pole taper over distance “CL” may be sufficiently significant such that the diameter of a first one of the clamps 32 may be smaller than the diameter of a second one of the clamps 32. (Assuming that the pole tapers in a direction from the second clamp 32 toward the first clamp 32.)

The elastic properties of the material from which the replacement guide of the present invention is fabricated may be able to accommodate an insignificant rate of pole taper and allow for installation and a snug fit to the pole.

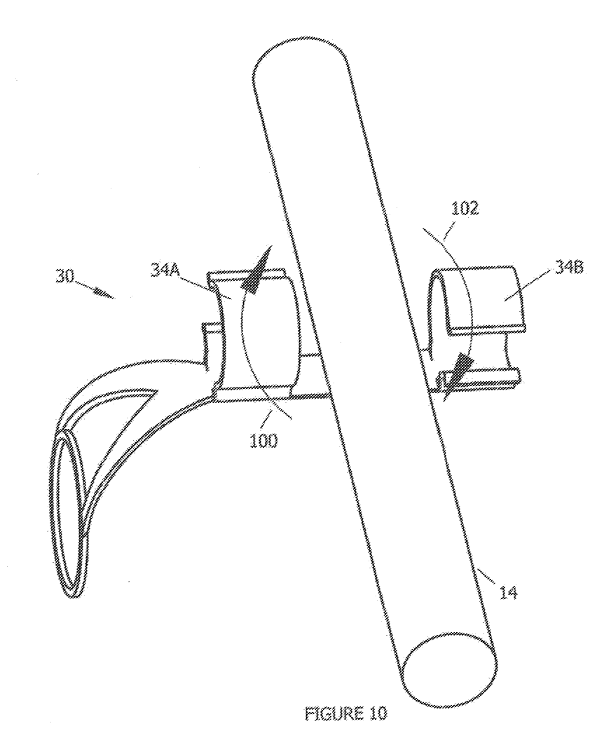

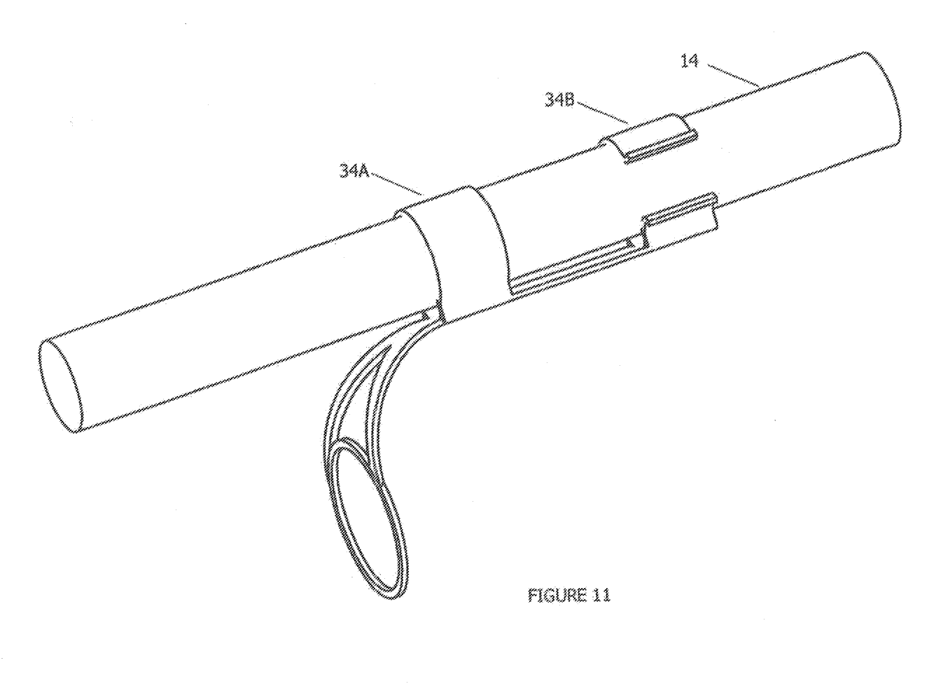

FIGS. 10 and 11 show the simplicity with which the replacement guide 30 can be connected to a fishing pole 14 quickly and without any prior experience.

With respect to the face of a typical clock, FIG. 10 shows a rod 14 arranged spanning between a 12 o'clock and a 6 o'clock position. Using the same clock reference, FIG. 10 also shows the invention with the clamp 34A in the 9 o'clock position and the clamp 34B in the 3 o'clock position.

The inventive clip is attached to the pole 14 by clockwise rotation of the replacement guide or clip apparatus 30, moving the clamp 34A to the 12 o'clock position removably attached to the pole 14 and the clamp 34B to the 6 o'clock position removably attached to the pole 14. Arrowheads 100 and 102 illustrate the clockwise rotation of the clip apparatus 30.

The result of this motion secures the clip apparatus 30 to the pole 14 as shown in FIG. 11.

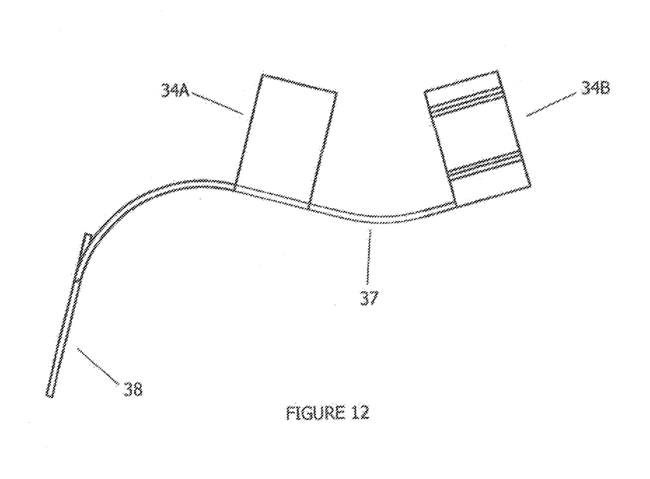

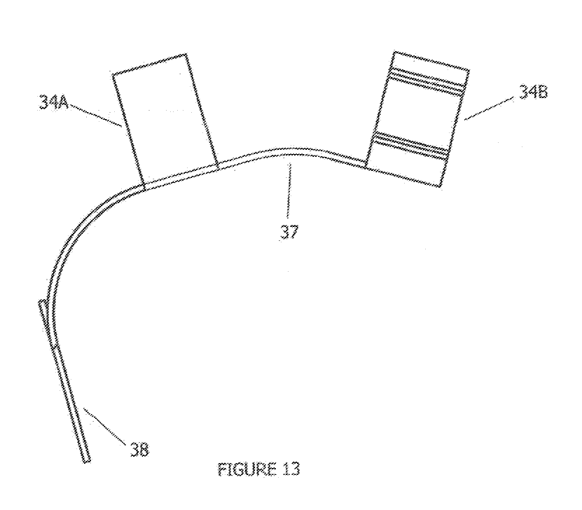

The bendable nature of the segment 37 between the two “C-shaped” clamps 34 is illustrated in FIGS. 12 and 13. In FIG. 12 the segment 37 is bent to form a “U-shaped” segment and in FIG. 13 the segment 37 is bent to form an inverted “U-shaped” segment.

There exist a nearly infinite number of possibilities for the position of the openings 34 (see FIG. 3) of the clamps 32. Two embodiments warrant discussion. The first embodiment is the aforementioned case where the openings 34 are spaced by about 180 degrees.

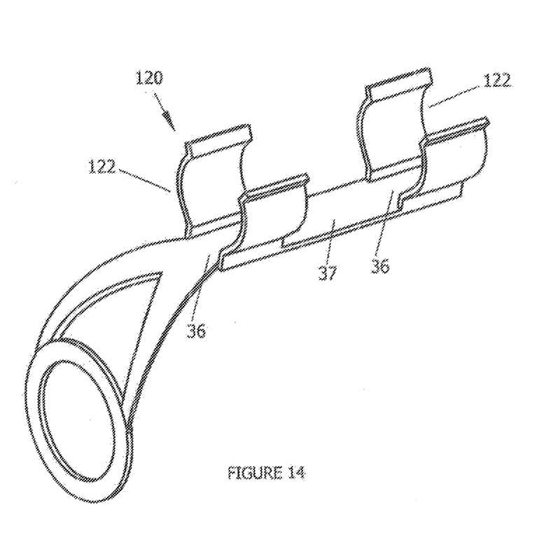

A second embodiment of a replacement guide or clip apparatus 120 comprises “U-shaped” clamps 122 as shown in FIG. 14.

In effect, to achieve the embodiment of FIG. 12 the clamps 32 of FIG. 3 are each rotated in opposite directions by 90 degrees. Thus rotation of the clamps 32 of FIG. 3 by any number of degrees reorients the openings 34, presenting different embodiments of the invention. Such different embodiments are all considered within the scope of the present invention and the presented claims.

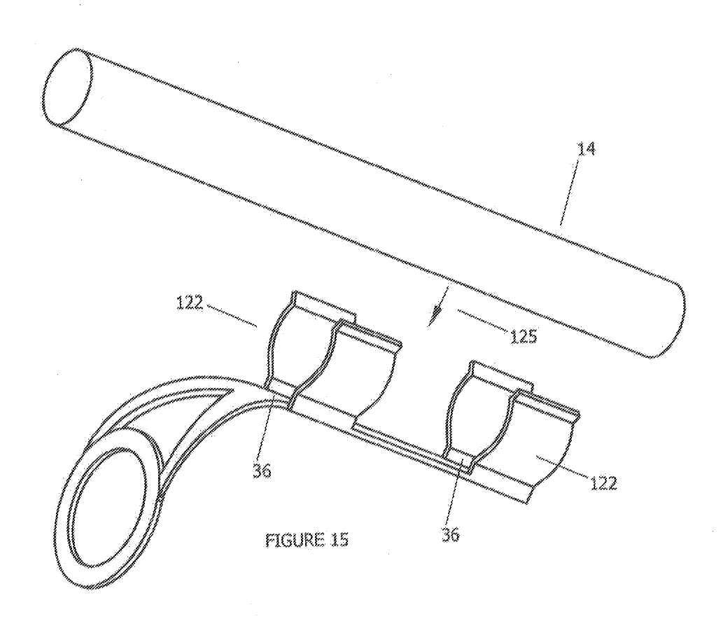

Steps for attaching the replacement guide 120 of FIG. 14 to the pole 14 are different than for the previously described embodiment. Instead of using a twisting motion as depicted in FIG. 10, the clip 120 is attached by applying a force perpendicular to the guide 120 until the pole 14 is securely captured within each “U-shaped” clamp 122. See FIG. 15 and a force vector 125. Any remaining vestiges of the broken guide feet, resin and thread are within the channels 36 of each clamp 122.

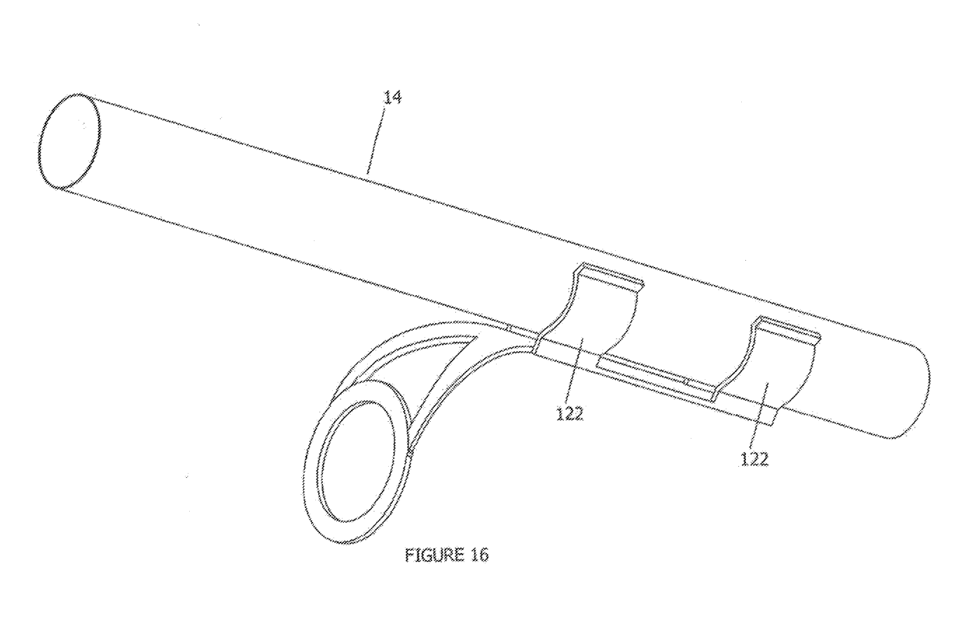

FIG. 16 illustrates the pole 14 captured by the U-shaped clamps 122.

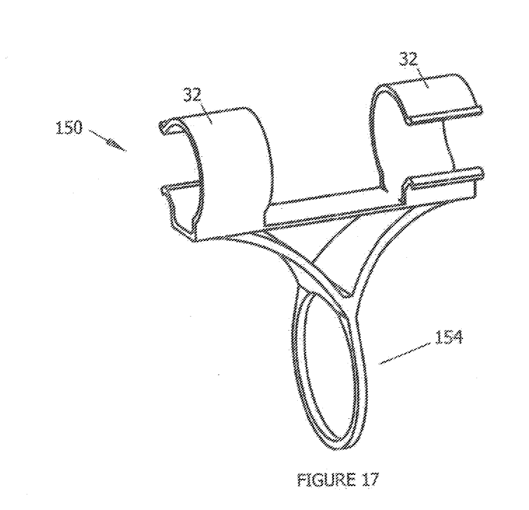

In yet another embodiment, in a clip 150 (see FIG. 17), the line guide or ring 154 is situated in a middle region of the clip 150, instead of at an end region of the clip as in the prior embodiments. The clip 150 is attached to the pole using the same techniques and forces as previously described with respect to FIG. 10. This embodiment provides the same functionality as the other embodiments.

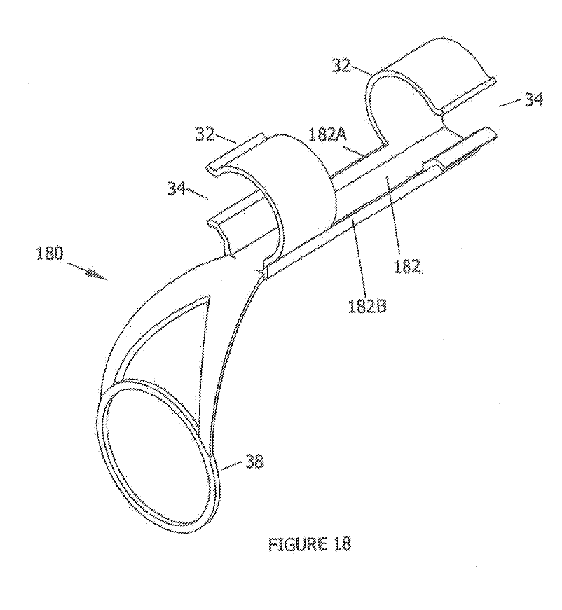

In an embodiment of a replacement guide 180 illustrated in FIG. 18, the flat bendable segment 37 (see FIG. 3) is replaced by a segment 182, which comprises upstanding side surfaces 182A and 182B that each function as an “I” beam and prevent the segment 182 from bending either upwardly or downwardly. This embodiment may not be preferred for use with a fishing pole that bends during use.

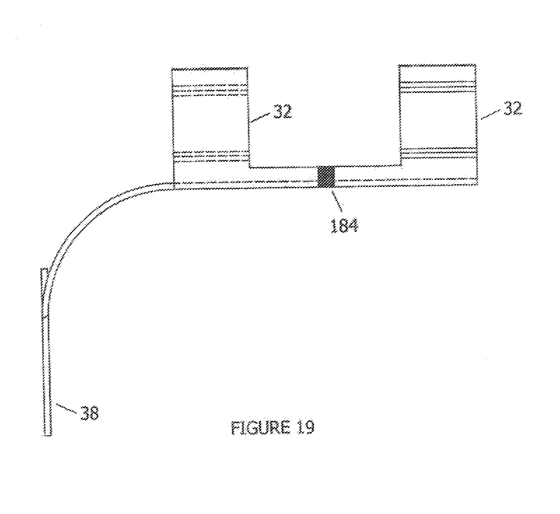

However, the embodiment of FIG. 19 permits bending within the segment 182 by disposing a stress relief material 184 within the segment 182. The stress relief material 184 permits the clip apparatus 180 to bend with the fishing pole as needed.

Generally, the dimensions of the component parts for any of the presented embodiments are approximately the same, dependent on a diameter and taper of the fishing pole with which the replacement guide will be used.

Although the embodiments of the invention have been shown and described with respect to certain preferred embodiments, it is obvious that alterations and modifications will occur to others skilled in the art upon the reading and understanding of this specification and the annexed drawings. In particular regard to the various functions performed by the above described components, the terms used to describe such components are intended to correspond, unless otherwise indicated, to any component that performs the specified function or an equivalent function of the described component (i.e., that is functionally equivalent), even though not structurally equivalent to the disclosed structure. In addition, while a particular feature of the invention may have been disclosed with respect to only one of several embodiments, such feature may be combined with one or more other features of the other embodiments as may be desired and advantageous for any given or particular application.

What is claimed is:

1. A replacement fishing line guide for a fishing pole comprising:
a bendable base;
at least a first and a second spaced-apart C-shaped clamp extending upwardly from the base, wherein the fishing pole is received within each of the first and second clamps, each clamp defining an opening therein, a first opening in the first clamp spaced a number of angular degrees from a second opening in the second clamp;
a channel defined in a lower region of each of the first and second clamps, the channel for receiving remnant portions of a broken fishing line guide;
a connecting segment extending from the base; and
a ring attached to the connecting segment for receiving a fishing line within the ring.

2. The replacement fishing line guide of claim 1 wherein a material of each of the first and second clamps comprises a spring-like material that exerts inwardly directed forces toward a center of the clamp to removably secure the replacement fishing line guide to the fishing pole.

3. The replacement fishing line guide of claim 1 wherein the first and second clamps are deformable radially outwardly to permit the fishing pole to pass through the first and second openings and then return to a pre-deformed state to exert the inwardly-directed forces.

4. The replacement fishing line guide of claim 1 wherein the spring-like material of the first and second clamps comprises a heat-treated material that imparts a spring-like property to the first and second clamps.

5. The replacement fishing line guide of claim 1 wherein the number of angular degrees is 180 angular degrees.

6. The replacement fishing line guide of claim 1 wherein the number of angular degrees is 0 angular degrees.

7. The replacement fishing line guide of claim 1 wherein the base has a relatively flat cross section.

8. The replacement fishing line guide of claim 1 wherein the base defines a channel extending between the first and the second clamps.

9. The replacement fishing line guide of claim 8 wherein the base further comprises a stress relief area imparting a bendable property to the base, the stress relief area between the first and second clamps.

10. The replacement fishing line guide of claim 1 wherein the bendable base is bendable in a direction perpendicular to a longitudinal axis of the base.

11. The replacement fishing line guide of claim 1 wherein the connecting segment extends from a first edge of the base.

12. The replacement fishing line guide of claim 1 wherein the connecting segment extends from a central region of the base, the central region between the first and second clamps.

13. The replacement fishing line guide of claim 1 wherein the connecting segment comprises a first connecting segment extending from a first lower surface region of the base beneath the first clamp, the replacement fishing line guide further comprising a second connecting segment extending from a second lower surface region of the base beneath the second clamp.

14. The replacement fishing line guide of claim 1 wherein first and second opposing edges of the first opening each comprise an outwardly extending lip.

15. The replacement fishing line guide of claim 1 wherein first and second opposing edges of the second opening each comprise an outwardly extending lip.

16. The replacement fishing line guide of claim 1 wherein the fishing pole is oriented perpendicular to and in contact with the base in a region of the base between the first and second clamps and is rotated to pass the fishing pole through the first and second openings to align a longitudinal axis of the replacement fishing line guide with the fishing pole.

17. A replacement fishing line guide for a fishing pole comprising:
a base bendable in a direction perpendicular to an upper surface of the base and bendable in a direction perpendicular to a lower surface of the base;
a first and a second spaced-apart C-shaped clamp extending upwardly from opposite ends of the base, wherein the fishing pole is received within each of the first and second clamps, each clamp defining an opening therein, a first opening in the first clamp spaced 180 angular degrees from a second opening in the second clamp, wherein a material of each of the first and second clamps comprises a spring-like material that exerts inwardly directed forces toward a center of the clamp to removably secure the replacement fishing line guide to the fishing pole.
a channel defined in a lower region of each of the first and second clamps, the channel for receiving remnant portions of a broken fishing line guide;
a connecting segment extending from a short edge the base; and
a ring attached to the connecting segment for receiving a fishing line within the ring.
